(19) United States
(12) Patent Application Publication
(10) Pub. No.: US 2013/0169052 A1
(43) Pub. Date: Jul. 4, 2013

(54) POWER SUPPLY WITH CUMULATIVE CONNECTIVITY OF BATTERIES AND POWER SUPPLY METHOD

(71) Applicant: CHUN-AN LAI, Tu-Cheng (TW)

(72) Inventor: CHUN-AN LAI, Tu-Cheng (TW)

(21) Appl. No.: 13/629,646

(22) Filed: Sep. 28, 2012

(30) Foreign Application Priority Data
Dec. 30, 2011 (TW) 100150039

(51) Int. Cl. H02J 1/00

(52) U.S. Cl. 307/71

(57) ABSTRACT

An power supply includes an output terminal, a switch module, a battery module including batteries, and a controller storing a threshold voltage and detecting an output voltage of the battery module. The battery module is connected to the output terminal through the switch module. One battery outputs the supply voltage until an output voltage of the battery is lower than the threshold, and then another battery outputs the supply voltage under control of the controller. The controller repeats such control until the output voltage of each battery is lower than the threshold. Then the controller instructs two or more batteries to be connected in series through the switch module, and in combination output the supply voltage to the load. When the output voltage of all the batteries connected in series is lower than the threshold, the controller controls the switch module to be disconnected from the output terminal.

### BACKGROUND

1. Technical Field

The disclosure generally relates to power supplies and power supply methods, and particularly to a direct-current power supply and a power supply method using the same.

2. Description of the Related Art

A conventional power supply of electronic devices is a direct-current (DC) power supply. If an output voltage of the DC power supply is lower than a working voltage of the electronic device, the power supply needs to be charged to ensure the normal operation of the electronic device. This is the case even when the power supply still has some residual electric energy stored therein. The residual electric energy cannot be utilized by the electronic device.

Therefore, there is room for improvement within the art.

### BRIEF DESCRIPTION OF THE DRAWINGS

Many aspects of an exemplary power supply and related method can be better understood with reference to the following drawings. The components in the drawings are not necessarily drawn to scale, the emphasis instead being placed upon clearly illustrating the principles of the exemplary power supply and related method. Moreover, in the drawings, like reference numerals designate corresponding parts throughout the views.

FIG. 1 is a block diagram of a power supply according to an exemplary embodiment.

FIG. 2 is a circuit diagram of the power supply shown in FIG. 1.

FIG. 3 is a flowchart illustrating a power supply method, according to an exemplary embodiment.

### DETAILED DESCRIPTION

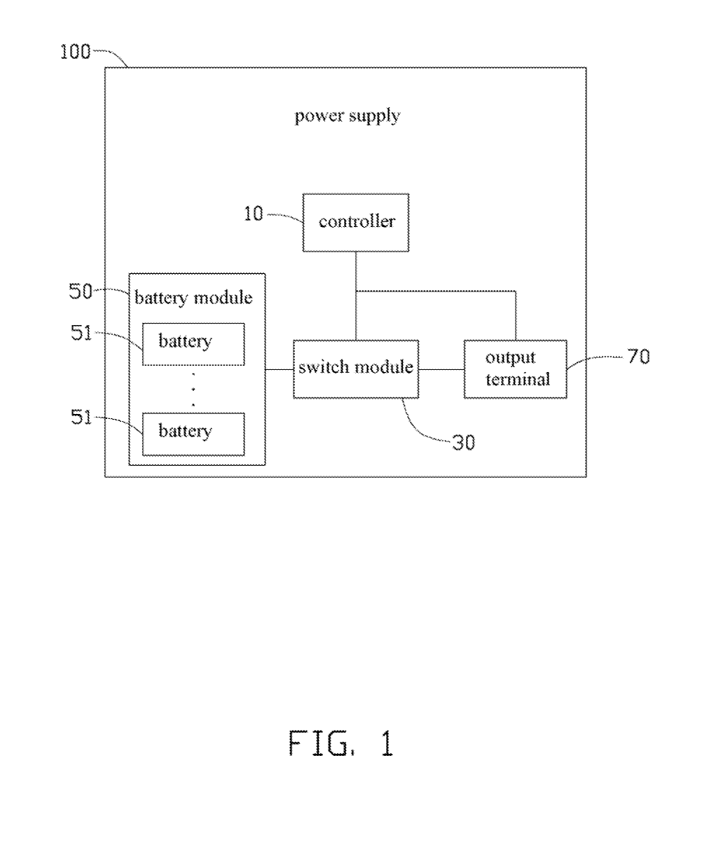

Referring to FIG. 1, a power supply 100 according to an exemplary embodiment is shown. The power supply 100 includes a controller 10, a switch module 30, a battery module 50, and an output terminal 70. The battery module 50 includes a plurality of batteries 51. Two or more of the batteries 51 can be electronically connected in series by the switch module 30, and then such group of electronically connected batteries 51 is electronically connected to the output terminal 70 through the switch module 30. The switch module 30 is electronically connected to the controller 10. When the switch module 30 is closed under the control of the controller 10, the battery module 50 outputs a supply voltage to a load (not shown) through the output terminal 70. In this exemplary embodiment, the plurality of batteries 51 may be dry batteries, storage batteries, etc, and the voltage of each battery 51 should be equal to the supply voltage of the power supply 100.

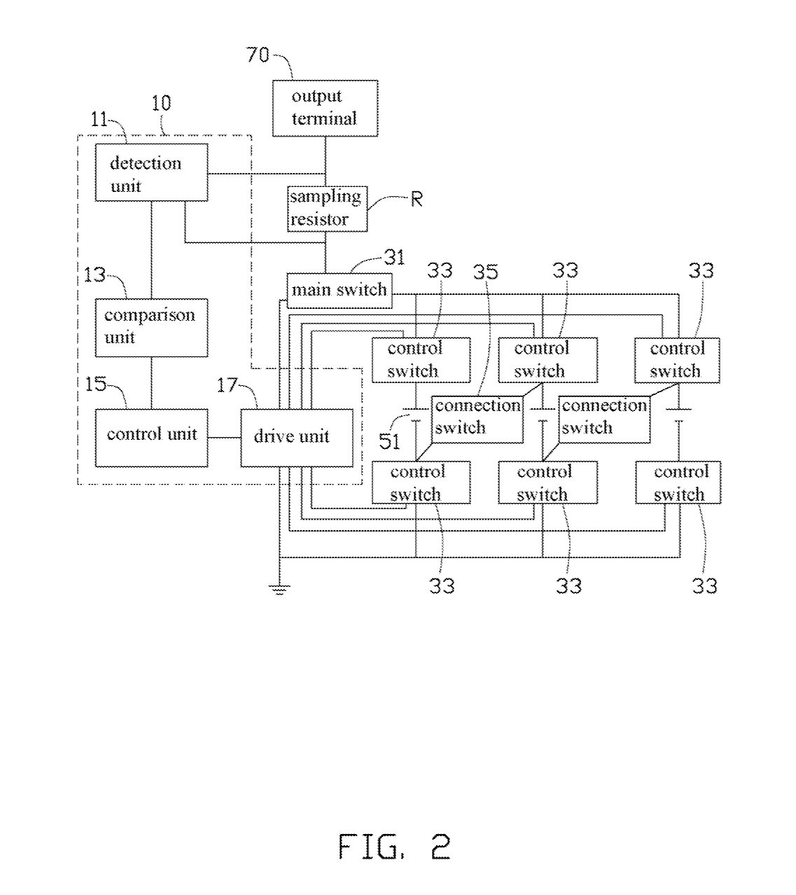

Referring also to FIG. 2, the controller 10 of the exemplary embodiment is shown. The controller 10 includes a detection unit 11, a comparison unit 13, a control unit 15, and a drive unit 17. The comparison unit 13 and the drive unit 17 are electronically connected to the control unit 15, and the detection unit 11 is electronically connected to the comparison unit 13. The detection unit 11 is electronically connected to the output terminal 70 to detect an output voltage of the battery module 50. The comparison unit 13 may be a comparator storing a threshold voltage. The comparison unit 13 determines whether the output voltage of the battery module 50 is lower than the threshold voltage; and if the output voltage of the battery module 50 is lower than the threshold voltage, the comparison unit 13 sends a difference signal to the control unit 15. In this exemplary embodiment, the threshold voltage should be equal to the supply voltage of the power supply 100. The control unit 15 receives the difference signal from the comparison unit 13, and instructs the drive unit 17 to adjust the switch module 30 to make the battery module 50 output the supply voltage to the load.

The switch module 30 includes a main switch 31, a plurality of control switches 33, and a plurality of connection switches 35. The main switch 31 is located between the output terminal 70 and the battery module 50, and connects the battery module 50 to the output terminal 70. Each battery 51 is connected between two corresponding control switches 33. An anode of the battery 51 is electronically connected to the main switch 31 through one of the corresponding control switches 33, and a cathode of the battery 51 is electronically connected to ground through the other corresponding control switch 33. Each connection switch 35 connects an anode of one battery 51 to a cathode of another adjacent battery 51. Thus, the plurality of batteries 51 can be connected in series in sequence by the control switches 33 and the connection switches 35. In this exemplary embodiment, the main switch 31, the plurality of control switches 33, and the plurality of connection switches 35 are field-effect transistors. Gate electrodes of the field-effect transistors are electronically connected to the drive unit 17. The drive unit 17 adjusts the voltages of the gate electrodes to selectively close or open the control switches 33 and the connection switches 35.

The control unit 15 may be a complex programmable logic device (CPLD). The control unit 15 provides a unique name for every battery 51 through programming, such as first battery, second battery, third battery, for example. The control unit 15 also provides unique names for every control switch 33 and every connection switch 35 through programming. The control unit 15 may precisely control the drive unit 17 to close or open the control switches 33 and the connection switches 35.

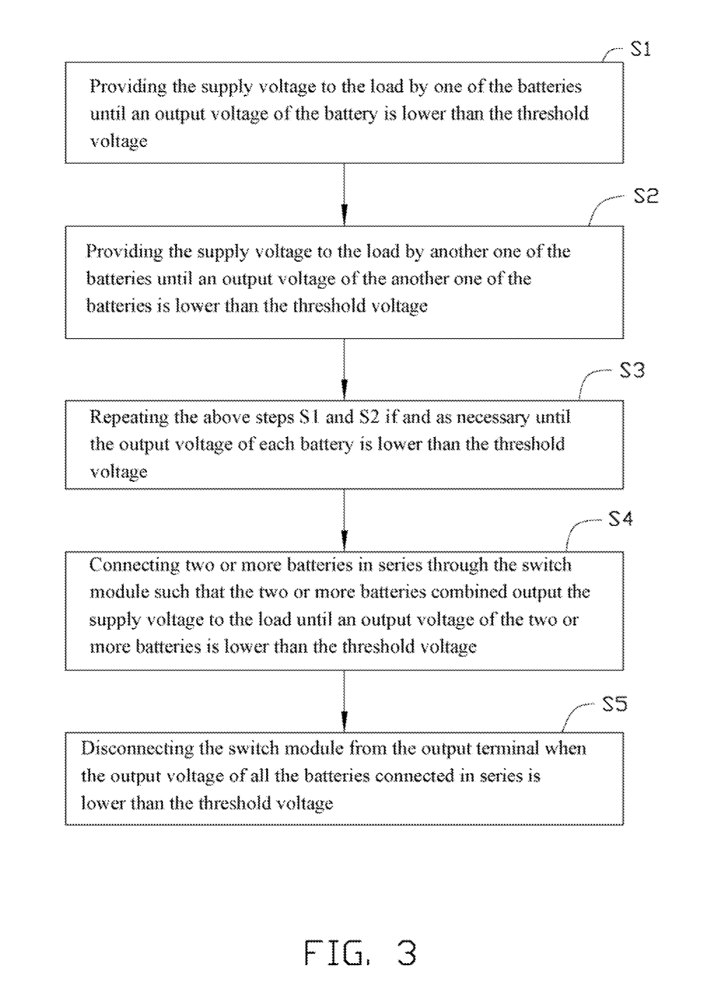

Referring also to FIG. 3, the power supply 100 functions as follows:

The drive unit 17 adjusts voltages of the gate electrodes to close the main switch 31 and two control switches 33 connecting to one battery 51, and to open the other control switches 33 and all the connection switches 35. Thus, only one battery 51 supplies power. The detection unit 11 detects an output voltage of the battery module 50, and sends the output voltage to the comparison unit 13. The comparison unit 13 determines whether the output voltage of the battery module 50 is lower than the threshold voltage. If the output voltage of the battery module 50 is lower than the threshold voltage, the comparison unit 13 sends a first difference signal to the control unit 15. According to the first difference signal, the control unit 15 instructs the drive unit 17 to open the two control switches 33 connecting to the battery 51, and instructs the drive unit 17 to close two control switches 33 connecting to another battery 51. The above steps are repeated if and as necessary until the output voltage of each battery 51 is lower than the threshold voltage. Then, the comparison unit 13 sends a second difference signal to the control unit 15. The control unit 15 instructs the drive unit 17 to close one or more connection switches 35 according to the second difference signal, and close two corresponding control switches 33, and thereby provide two or more batteries 51 connected in series. The plurality of batteries 51 connected in series provide a combined voltage which is equal to the supply voltage.

As mentioned above, the plurality of control switches 33 are field-effect transistors. Gate electrodes of the plurality of control switches 33 are electronically connected to the drive unit 17, and the drive unit 17 adjusts voltages of the gate electrodes to selectively close or open the control switches 33. The control unit 15 instructs the drive unit 17 to open the main switch 31 until the output voltage of all the batteries 51 connected in series is lower than the threshold voltage. At that point, the power supply 100 needs to be charged.

The power supply 100 further includes a sampling resistor R. The main switch 31 is electronically connected to the output terminal 70 through the sampling resistor R. The detection unit 11 detects a current of the sampling resistor R, and sends the current to the comparison unit 13. The comparison unit 13 stores a threshold current, and determines whether the current of the sampling resistor R exceeds the threshold current.

If the current of the sampling resistor R exceeds the threshold current, the comparison unit 13 sends an over-current signal to the control unit 15, and the control unit 15 instructs the drive unit 17 to open the main switch 31 to protect the load.

Each battery 51 can supply power alone. When the output voltage of each battery 51 is lower than the supply voltage of the power supply 100, two or more batteries 51 can be connected in series to provide a combined voltage which is equal to the supply voltage under the control of the controller 10, until the output voltage of all the batteries 51 connected in series is lower than the supply voltage. Thus the power supply 100 has high utilization of the battery module 50.

In alternative embodiments, the threshold voltage can be a little higher than the supply voltage of the power supply 100.

Referring to FIG. 3, this shows a power supply method for the power supply 100 to provide a supply voltage to a load, according to an exemplary embodiment.

In step S1, the power supply 100 provides the supply voltage to the load by one of the batteries 51 until an output voltage of the battery 51 is lower than the threshold voltage.

In step S2, the power supply 100 provides the supply voltage to the load by another one of the batteries 51 until an output voltage of the another one of the batteries 51 is lower than the threshold voltage.

In step S3, steps S1 and S2 are repeated if and as necessary until the output voltage of each battery 51 is lower than the threshold voltage.

In step S4, two or more batteries 51 are connected in series through the switch module 30 such that the two or more batteries 51 combined output the supply voltage to the load until an output voltage of the two or more batteries 51 is lower than the threshold voltage.

In step S5, the controller 10 disconnects the switch module 30 from the output terminal 70 when the output voltage of all the batteries 51 connected in series is lower than the threshold voltage.

The power supply method has high utilization of the battery module 50.

It is to be understood, however, that even though numerous characteristics and advantages of exemplary embodiments have been set forth in the foregoing description, together with details of the structures and functions of the exemplary embodiments, the disclosure is illustrative only, and changes may be made in detail, especially in matters of arrangement of parts within the principles of the disclosure to the full extent indicated by the broad general meaning of the terms in which the appended claims are expressed.

What is claimed is:

1. A power supply for providing a supply voltage to a load, comprising:
an output terminal for outputting the supply voltage;
a switch module electronically connectable to the output terminal;
a battery module comprising a plurality of batteries, the battery module electronically connected to the output terminal through the switch module; and
a controller electronically connected to the switch module and the output terminal, the controller storing a threshold voltage and detecting an output voltage of the battery module;
wherein one of the batteries outputs the supply voltage to the load until an output voltage of the battery is lower than the threshold voltage, then another one of the batteries outputs the supply voltage to the load under the control of the controller until an output voltage of the another one of the batteries is lower than the threshold voltage, and the controller repeats such control if and as necessary until the output voltage of each battery is lower than the threshold voltage;
when the output voltage of each battery is lower than the threshold voltage, the controller instructs two or more batteries to be connected in series through the switch module such that the two or more batteries combined output the supply voltage to the load until an output voltage of the two or more batteries is lower than the threshold voltage; and
when the output voltage of all the batteries connected in series is lower than the threshold voltage, the controller controls the switch module to be disconnected from the output terminal.

2. The power supply of claim 1, wherein the controller comprises a detection unit electronically connected to the output terminal, a comparison unit storing the threshold voltage, and a control unit; the detection unit is adapted to detect the output voltage of the battery module; the comparison unit determines whether the output voltage of the battery module is lower than the threshold voltage; and the control unit is electronically connected to the switch module.

3. The power supply of claim 2, wherein the switch module comprises a plurality of control switches and a plurality of connection switches, each two of the control switches is electronically connected to one of the batteries, with an anode of the battery electronically connected to one of the two control switches, and a cathode of the battery electronically connected to ground through the other one of the two control switches; and each connection switch electronically connects an anode of one battery to a cathode of another adjacent battery.

4. The power supply of claim 3, wherein the switch module further comprises a main switch connecting the battery module to the output terminal.

5. The power supply of claim 4, wherein the main switch, the plurality of control switches, and the plurality of connection switches are field-effect transistors, and gate electrodes of the field-effect transistors are electronically connected to the controller.

6. The power supply of claim 4, further comprising a sampling resistor, wherein the main switch is electronically connected to the output terminal through the sampling resistor, and the detection unit detects a current of the sampling resistor.

7. The power supply of claim 5, wherein the controller further comprises a drive unit electronically connected to the control unit, and the gate electrodes of the field-effect transistors are electronically connected to the drive unit.

8. The power supply of claim 2, wherein the threshold voltage is equal to or slightly higher than the supply voltage.

9. A power supply for providing a supply voltage to a load, comprising:
an output terminal for outputting the supply voltage;
a switch module comprising a plurality of control switches and a plurality of connection switches;
a battery module comprising a plurality of batteries, the battery module electronically connected to the output terminal through the switch module; and
a controller electronically connected to the switch module and the output terminal, the controller storing a threshold voltage and detecting an output voltage of the battery module;
wherein each two of the control switches is electronically connected to one battery, with an anode of the battery electronically connected to one of the two control switches, and a cathode of the battery electronically connected to ground through the other one of the two control switches;
each connection switch electronically connects an anode of one battery to a cathode of another adjacent battery;
one battery outputs the supply voltage to the load until an output voltage of the battery is lower than the threshold voltage, then another battery outputs the supply voltage to the load under the control of the controller until an output voltage of the another battery is lower than the threshold voltage, and the controller repeats such control if and as necessary until the output voltage of each battery is lower than the threshold voltage;
when the output voltage of each battery is lower than the threshold voltage, the controller instructs two or more batteries to be connected in series through one or more corresponding of the connection switches such that the two or more batteries combined output the supply voltage to the load until an output voltage of the two or more batteries is lower than to the threshold voltage; and
when the output voltage of all the batteries connected in series is lower than the threshold voltage, the controller controls the switch module to be disconnected from the output terminal.

10. The power supply of claim 9, wherein the controller comprises a detection unit electronically connected to the output terminal, a comparison unit storing the threshold voltage, and a control unit; the detection unit is adapted to detect the output voltage of the battery module; the comparison unit determines whether the output voltage of the battery module is lower than the threshold voltage; and the control unit is electronically connected to the switch module.

11. The power supply of claim 10, wherein the switch module further comprises a main switch connecting the battery module to the output terminal.

12. The power supply of claim 11, wherein the main switch, the plurality of control switches, and the plurality of connection switches are field-effect transistors, and gate electrodes of the field-effect transistors are electronically connected to the controller.

13. The power supply of claim 11, further comprising a sampling resistor, wherein the main switch is electronically connected to the output terminal through the sampling resistor, and the detection unit detects a current of the sampling resistor.

14. The power supply of claim 12, wherein the controller further comprises a drive unit electronically connected to the control unit, and the gate electrodes of the field-effect transistors are electronically connected to the drive unit.

15. The power supply of claim 10, wherein the threshold voltage is equal to or slightly higher than the supply voltage.

16. A power supply method for a power supply to provide a supply voltage to a load, the power supply comprising: an output terminal for outputting the supply voltage; a switch module electronically connectable to the output terminal; a battery module comprising a plurality of batteries, the battery module electronically connected to the output terminal through the switch module; and a controller electronically connected to the switch module and the output terminal, the controller storing a threshold voltage and detecting an output voltage of the battery module; the power supply method comprising:
providing the supply voltage to the load by one of the batteries until an output voltage of the battery is lower than the threshold voltage;
providing the supply voltage to the load by another one of the batteries until an output voltage of the another one of the batteries is lower than the threshold voltage;
repeating providing the supply voltage to the load by another one of the batteries until an output voltage of the another one of the batteries is lower than the threshold voltage if and as necessary until the output voltage of each battery is lower than the threshold voltage;
connecting two or more batteries in series through the switch module such that the two or more batteries combined output the supply voltage to the load until an output voltage of the two or more batteries is lower than the threshold voltage; and
disconnecting the switch module from the output terminal when the output voltage of all the batteries connected in series is lower than the threshold voltage.

17. The power supply method of claim 16, wherein the controller comprises a detection unit electronically connected to the output terminal, a comparison unit storing the threshold voltage, and a control unit; the detection unit is adapted to detect the output voltage of the battery module; the comparison unit determines whether the output voltage of the battery module is lower than the threshold voltage; and the control unit is electronically connected to the switch module.

18. The power supply method of claim 17, wherein the switch module comprises a plurality of control switches and a plurality of connection switches, each two of the control switches is electronically connected to one of the batteries, with an anode of the battery electronically connected to one of the two control switches, and a cathode of the battery electronically connected to ground through the other one of the two control switches; and each connection switch electronically connects an anode of one battery to a cathode of another adjacent battery.

19. The power supply method of claim 18, wherein the switch module further comprises a main switch connecting the battery module to the output terminal.

20. The power supply method of claim 19, wherein the main switch, the plurality of control switches, and the plurality of connection switches are field-effect transistors, and gate electrodes of the field-effect transistors are electronically connected to the controller.
